(19) United States
(12) Patent Application Publication
(10) Pub. No.: US 2010/0164869 A1
(43) Pub. Date: Jul. 1, 2010

(54) VIRTUAL KEYBOARD STRUCTURE OF ELECTRIC DEVICE AND DATA INPUTTING METHOD THEREOF

(76) Inventors: Frank HUANG, Shanghai City (CN); Robin Yang, Shanghai City (CN); Wei HE, Shanghai City (CN); Stephen Zhu, Shanghai City (CN)

Correspondence Address: Muncy, Geissler, Olds & Lowe, PLLC, 4000 Legato Road, Suite 310, FAIRFAX, VA, 22033, US

(21) Appl. No.: 12/647,273

(22) Filed: Dec. 24, 2009

(30) Foreign Application Priority Data
Dec. 26, 2008 (TW) 097150950

(51) Int. Cl. G06F 3/02

(52) U.S. Cl. 345/168

(57) ABSTRACT

A virtual keyboard structure of an electronic device includes a projection module, two vibration sensors, a storage module, and a processor. The projection module is used for projecting a virtual keyboard having virtual keys. The two vibration sensors are used for detecting a center of vibration when the virtual keyboard is knocked on the center to obtain data of two directions. The storage module is used for storing dimensions of a coordinate system, a plurality of press-key data, coordinates of the virtual keys, and two respective reference positions of the vibration sensors. Finally, the processor is used for computing a coordinate of the vibration center and for matching the coordinate of the vibration center in the coordinates of the virtual keys to obtain a target virtual key corresponding to the vibration center and outputting one of the press-key data corresponding to the target virtual key.

### CLAIM FOR PRIORITY

This application claims the benefit of Taiwan Patent Application No. 097150950, filed on Dec. 26, 2008, which is hereby incorporated by reference for all purposes as if fully set forth.

### BACKGROUND OF THE INVENTION

1. Field of Invention

The present invention relates to a virtual keyboard structure, and more particularly to a virtual keyboard structure having vibration sensors and a data inputting method.

2. Related Art

The conventional virtual keyboard structure configured to an electronic device includes a laser light source, a photodetector and a processing unit. The laser light source can emanate a laser beam forming a virtual keyboard and the virtual keyboard includes a plurality of virtual keys. When the virtual keyboard is pressed by a finger or an object, the laser beam will be reflected and received by the photodetector. Depending upon a direction angle and a required time of reflection of the laser beam, the processing unit can compute which virtual key is pressed and output the press-key data corresponding to the virtual key, such as a character, a number, or a command.

However, many technical problems still need to be solved. For example, when the electronic device configured with the conventional virtual keyboard structure is disposed in a too-bright or dusky environment, the incorrect determination problem of the press-key is easily occurred because the photodetector is interrupted by reflections of other light sources or glossy objects.

### SUMMARY OF THE INVENTION

Accordingly, the present invention is direct to a virtual keyboard structure and a data inputting method thereof, wherein a center of vibration is detected when a virtual key is pressed on the virtual keyboard, and the press-key data corresponding to the virtual key is outputted.

A technical means provided by the present invention discloses a virtual keyboard structure of an electronic device. This virtual keyboard structure includes a projection module, two vibration sensors, a storage module and a processor.

The projection module is used for projecting a virtual keyboard on a surface, and the virtual keyboard includes a plurality of virtual keys. The two vibration sensors are disposed on a side of the electronic device and each vibration sensor is used to detect a center of vibration on the surface when the virtual keyboard is knocked on the center and when the side overlaps the surface, in order to obtain data of two-directions from the center to the two vibration sensors respectively. The storage module stores dimensions of a coordinate system, a plurality of plural press-key data corresponding to the virtual keys, coordinates of the virtual keys in the coordinate system, and two reference positions of the vibration sensors in the coordinate system. Based on the dimensions, the reference positions, and the two-directions data of the vibration center, the processor computes at least a coordinate of the vibration center and the processor matches the coordinate of the vibration center in the virtual keys, so as to obtain a target virtual key corresponding to the vibration center and to output one of the press-key data corresponding to the target virtual key.

A technical means provided by the present invention discloses a data inputting method of a virtual keyboard structure, which is applied to an electronic device to have a function of projecting a virtual keyboard on a surface. The virtual keyboard includes a plurality of virtual keys and the electronic device stores dimensions of a coordinate system, a plurality of press-key data corresponding to the virtual keys, and coordinates of the virtual keys in the coordinate system. This data inputting method includes steps of: using two vibration sensors to detect a center of vibration on the surface when the virtual keyboard is knocked on the center, in order to obtain data of two-directions from the center to the two vibration sensors respectively; computing at least a coordinate of the vibration center based on the dimensions of a coordinate system, two respective reference positions of the vibration sensors in the coordinate system; and matching the coordinate of the vibration center in the coordinates of the virtual keys to obtain a target virtual key corresponding to the vibration center from the virtual keys and outputting one of the press-key data corresponding to the target virtual key.

The virtual keyboard structure of the present invention is not affected by background light; therefore, when a projecting virtual keyboard is knocked by fingers of a user, a center of vibration on the surface of the virtual keyboard can be accurately detected. Then, the coordinate of the vibration center in the coordinates of the virtual keys can be matched to obtain and output the press-key data. In addition, this structure can be compatible to an existing virtual keyboard technology, which indicates that a direction angle and time of reflectional lights can be used to amend the coordinate of the vibration center to accurately compute the virtual key that is knocked, thereby improving accuracy of data input of the virtual keyboard.

To enable a further understanding of the objectives and the technological methods of the invention herein, the brief description of the drawings below is followed by the detailed description of the preferred embodiments.

### BRIEF DESCRIPTION OF THE DRAWINGS

The present invention will become more fully understood from the detailed description given herein below for illustration only, and thus are not limitative of the present invention, and wherein:

FIG. 1A shows a block diagram of structures of a first embodiment of the present invention.

FIG. 1B shows a schematic view of a press-key which is knocked by a finger according to a first embodiment of the present invention.

FIG. 1C shows a schematic view of waves transmitted from a center of vibration according to a first embodiment of the present invention.

FIG. 1D shows a schematic view of computing a coordinate of a vibration center according to a first embodiment of the present invention.

FIG. 2 shows a flow diagram of a first embodiment of the present invention.

FIG. 3A shows a block diagram of structures of a second embodiment of the present invention.

FIG. 3B shows a schematic view of a press-key which is knocked by a finger according to a second embodiment of the present invention.

### DETAILED DESCRIPTION OF THE INVENTION

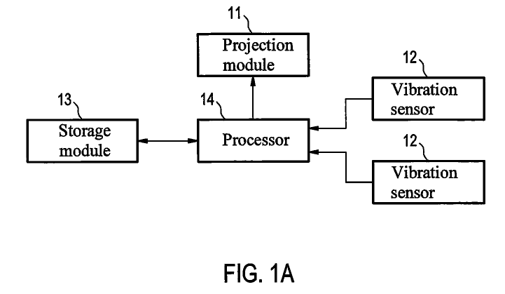

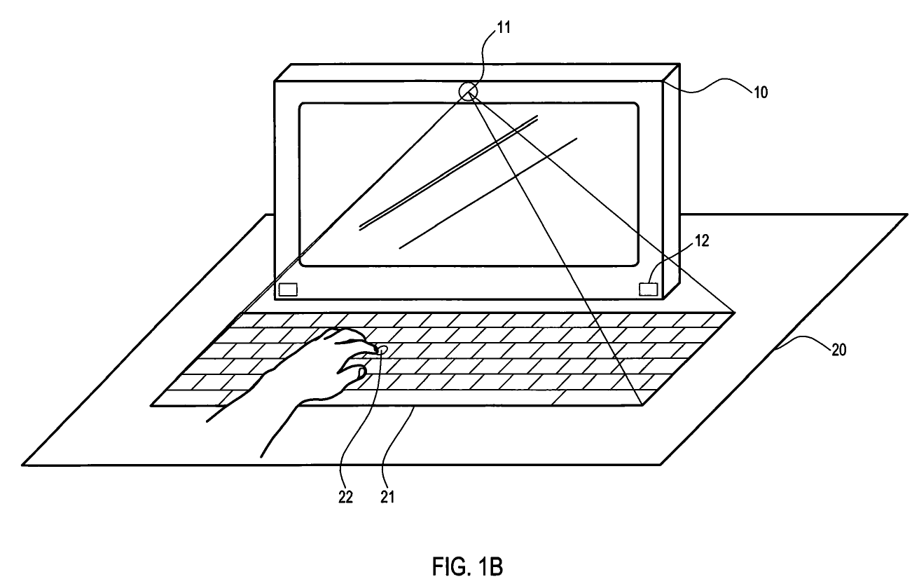

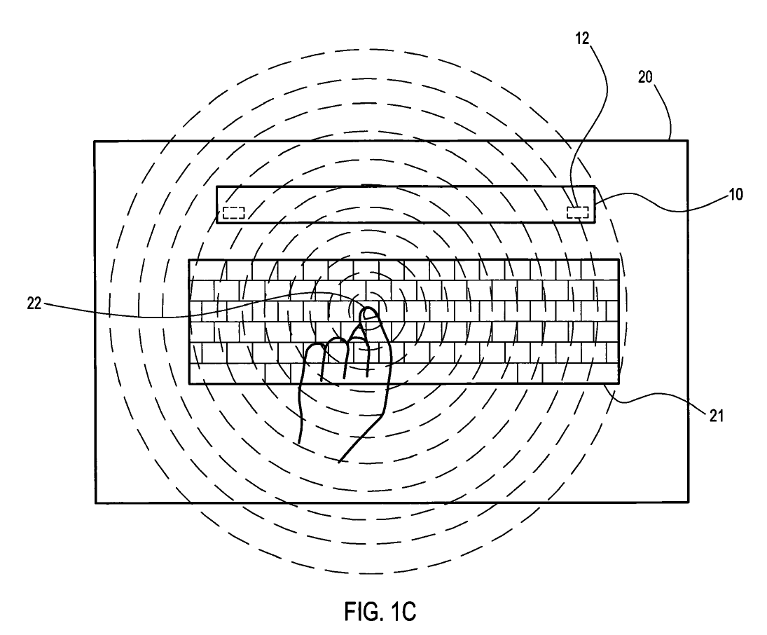

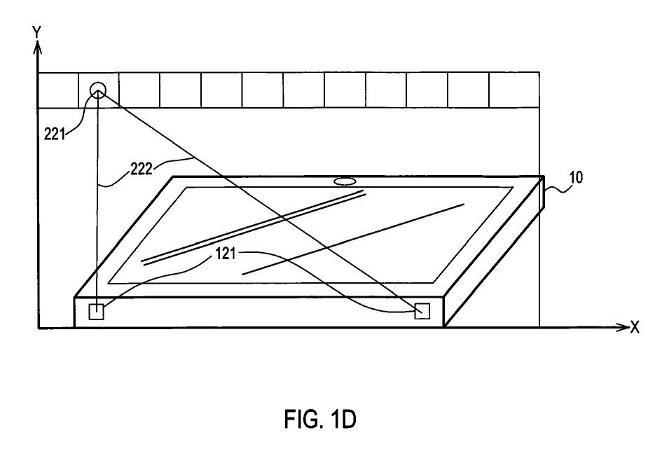

Refer to FIGS. 1A, 1B, 1C and 1D simultaneously. FIG. 1A is a block diagram of structures of a first embodiment of the present invention. FIG. 1B is a schematic view of a press-key which is knocked by a finer according to a first embodiment of the present invention. FIG. 1C is a schematic view of waves transmitted from a center of vibration 22 according to a first embodiment of the present invention. FIG. 1D is a schematic view of computing a coordinate of a center of vibration according to a first embodiment of the present invention. The electronic device presents in the present invention can be a personal digital assistant, a cellular phone, a computer, or a Tablet PC. The embodiment hereinafter is described with a tablet PC 10 as an example.

This virtual keyboard is applied to an electronic device and comprises a projection module 11, two vibration sensors 12, a storage module 13 and a processor 14.

The projection module 11 is configured at a top end of the tablet PC 10 and used for projecting a virtual keyboard on a surface (as shown in FIG. 1B), and the virtual keyboard includes a plurality of virtual keys. The two vibration sensors 12 are disposed on a side of the tablet PC 10. In the present embodiment, the vibration sensors 12 are configured at a bottom of the tablet PC 10 and are evenly located at two sides of this bottom surface (as shown in FIG. 1B).

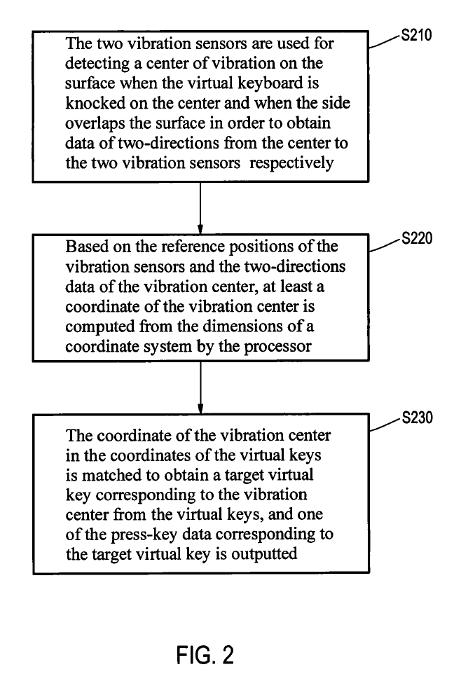

The storage module 13 is used for storing dimensions of a coordinate system, a plurality of press-key data corresponding to the virtual keys, coordinates of the virtual keys in the coordinate system, and two respective reference positions 121 of the vibration sensors 12 in the coordinate system. The processor 14 is electrically coupled with the projection module 11, the vibration sensors 12 and the storage module 13, respectively. Referring to FIG. 2, it shows a flow diagram of a first embodiment of the present invention, applied to the electronic device as shown in FIGS. 1A, 1B, 1C and 1D. The projection module 11 of the tablet PC 10 is used to project an image of a virtual keyboard 21 on the surface 20 on which the electronic device is put, and the virtual keyboard 21 includes plural virtual press-keys, with an image of each virtual press-key being marked with a function that the virtual press-key is provided with or a character or symbol that is to be inputted. The image of this virtual keyboard 21 can be pre-stored in the storage module 13 or directly stored in the projection module 11.

The two vibration sensors 12 are used for detecting a center of vibration 22 on the surface 20 when the virtual keyboard 21 is knocked on the center and when the side overlaps the surface 20 in order to obtain data of two-directions 222 from the center to the two vibration sensors 12 respectively (step S210).

The processor 14 is used for computing at least a coordinate of the vibration center 22 based on the dimensions of the coordinate system, the reference positions 121, and the two-directions data 222

When a user knocks any of the virtual press-keys, a vibration signal corresponding to the knocked position on the surface 20 is generated. Herein, the knocked position corresponding to the vibration signal is taken as the vibration center 22 (as shown in FIG. 1C).

These two vibration sensors 12 receive this vibration signal respectively to obtain a direction and angle (i.e., an orientation of the vibration center 22 with the vibration sensor 12 as a center) of the vibration center 22 with respect to each vibration sensor 12, so as to obtain two-directions data 222 of the vibration center 22. The vibration sensors 12 determine a position of the vibration center 22 based on a time difference between times when the two vibration sensors 12 respectively detect the vibration center 22 or a ratio between vibration intensities at the vibration center 22 detected respectively by the two vibration sensors 12 so as to obtain the two-directions data 222.

Based on the reference positions 121 of the vibration sensors 12 and the two-directions data 222 of the vibration center 22, at least a coordinate of the vibration center 221 is computed from the dimensions of a coordinate system by the processor 14 (step S220).

The processor 14 will obtain the dimensions of a coordinate system from the storage module 13 to set up a coordinate axis, and combine all the coordinates of the virtual keys with the two reference positions 121 of the vibration sensors 12 on the coordinate axis (as shown in FIG. 1D). Next, according to the two-directions data 222 of the vibration center 22 from the two vibration sensors 12, the processor 14 will draw two direction lines on the coordinate axis using the aforementioned two reference positions 121 as starting points. These two direction lines should be along a different axis direction and can be intersected. The processor 14 then obtains the coordinate of the vibration center 221 based on an intersected position of the two direction lines.

The coordinate of the vibration center 221 is matched in the coordinates of the virtual keys to obtain a target virtual key corresponding to the vibration center 221 from the virtual keys, and one of the press-key data corresponding to the target virtual key is outputted (step S230).

The processor 14 matches the coordinate of the vibration center 221 in the coordinates of the virtual keys for obtaining a target virtual key corresponding to the vibration center 22 from the virtual keys. Then the processor 14 outputs the press-key data corresponding to the target virtual key; besides, the processor 14 provides a function of amending the coordinate of the vibration center 221 based on the pressing coordinate and the electronic device will display or execute a related character, symbol, function or command, according to the outputted press-key data.

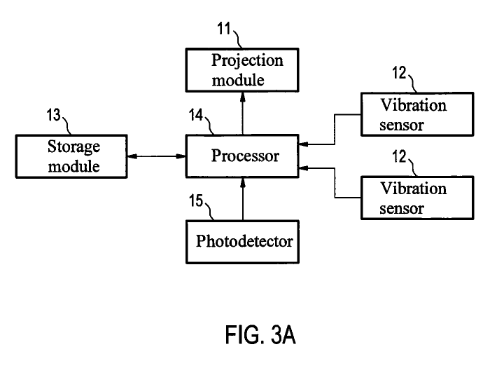

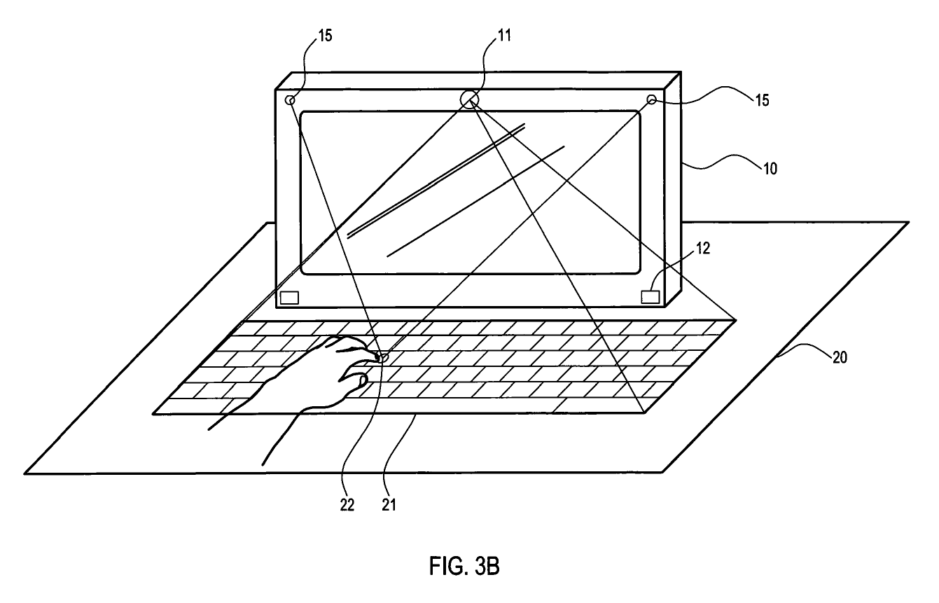

Referring to FIG. 3A and FIG. 3B at a same time, with FIG. 3A a block diagram of structures of a second embodiment of the present invention, the second embodiment differs from the first embodiment in that the virtual keyboard structure of the second embodiment further includes at least one photodetector 15.

The photodetector 15 is used for detecting a position where the virtual keyboard 21 is pressed to generate a coordinate of pressing. When fingers of the user press the virtual keyboard 21 that is projected by the projection module 11, the fingers of the user will reflect lights which are emanated from the aforementioned projection module 11 to form reflectional lights. The photodetector 15 receives the reflectional lights and a space between each of fingers and the photodetector 15 will be computed for determining coordinates of the fingers in the coordinate system based on direction angles of the reflectional lights and a time it takes to receive each of the reflectional lights. In addition, the processor 14 amends the coordinate of the vibration center based on the finger coordinates.

Besides, the processor 14 can also determine whether the user is pressing a virtual key based on the direction angle at which the reflectional light is obtained and the receiving time (for example, if it is assured that the reflectional light of the finger moves from bottom to top and then moves from top to bottom, then an operation of knocking a press-key is determined) and then induce a position where the user presses the virtual key based on a distance and the direction angle of the reflectional light, to generate a click coordinate. The processor 14 will next correct the coordinate of the vibration center 221 according to this click coordinate.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A virtual keyboard structure of an electronic device, comprising:
a projection module for projecting a virtual keyboard on a surface, wherein the virtual keyboard includes a plurality of virtual keys;
two vibration sensors disposed on a side of the electronic device and for detecting a center of vibration on the surface when the virtual keyboard is knocked on the center and when the side overlaps the surface, in order to obtain data of two directions from the center to the two vibration sensors respectively;
a storage module for storing dimensions of a coordinate system, a plurality of press-key data corresponding to the virtual keys, coordinates of the virtual keys in the coordinate system, and two respective reference positions of the vibration sensors in the coordinate system; and
a processor for computing at least a coordinate of the vibration center based on the dimensions, the reference positions, and the two-directions data, and for matching the coordinate of the vibration center in the coordinates of the virtual keys for obtaining a target virtual key corresponding to the vibration center and outputting one of the press-key data corresponding to the target virtual key.

2. The virtual keyboard structure of an electronic device according to claim 1, further comprising at least one photodetector for detecting a position where the virtual keyboard is pressed, in order to generate a coordinate of pressing, with the processor having a function of amending the coordinate of the vibration center based on the pressing coordinate.

3. The virtual keyboard structure of an electronic device according to claim 2, wherein the photodetector receives reflectional lights from fingers of a user pressing the virtual keyboard, and computes a distance between each of the fingers and the photodetector, for determining coordinates of the fingers in the coordinate system, based on direction angles of the reflectional lights and a time it takes to receive each of the reflectional lights, and the processor amends the coordinate of the vibration center based on the finger coordinates.

4. The virtual keyboard structure of an electronic device according to claim 1, wherein the vibration sensors determine a position of the vibration center based on a time difference between times when the two vibration sensors respectively detect the vibration center, for obtaining the two-directions data.

5. The virtual keyboard structure of an electronic device according to claim 1, wherein the vibration sensors determine a position of the vibration center based on a ratio between vibration intensities at the vibration center detected respectively by the two vibration sensors, for obtaining the two-directions data.

6. The virtual keyboard structure of an electronic device according to claim 1, wherein the electronic device comprises a cellular phone, a personal digital assistant, a computer, or a Tablet PC.

7. A data inputting method of a virtual keyboard structure, applied to an electronic device having a function of projecting a virtual keyboard on a surface, the virtual keyboard including a plurality of virtual keys and the electronic device storing dimensions of a coordinate system, a plurality of press-key data corresponding to the virtual keys, and coordinates of the virtual keys in the coordinate system, the data inputting method comprising:
using two vibration sensors to detect a center of vibration on the surface when the virtual keyboard is knocked on the center, in order to obtain data of two directions from the center to the two vibration sensors respectively;
computing at least a coordinate of the vibration center based on the dimensions, two respective reference positions of the vibration sensors in the coordinate system, and the two-directions data; and
matching the coordinate of the vibration center in the coordinates of the virtual keys for obtaining a target virtual key corresponding to the vibration center from the virtual keys and outputting one of the press-key data corresponding to the target virtual key.

8. The data inputting method of a virtual keyboard structure according to claim 7, further comprising the following steps:
detecting a position where the virtual keyboard is pressed, so as to generate a coordinate of pressing; and
amending the coordinate of the vibration center based on the pressing coordinate.

9. The data inputting method of a virtual keyboard structure according to claim 7, wherein to obtain the two-directions data comprises:
using the vibration sensors to determine a position of the vibration center based on a time difference between times when the two vibration sensors respectively detect the vibration center.

10. The data inputting method of a virtual keyboard structure according to claim 7, wherein to obtain the two-directions data comprises:
using the vibration sensors to determine a position of the vibration center based on a ratio between vibration intensities at the vibration center detected respectively by the two vibration sensors.
